(19) United States
(12) Patent Application Publication
(10) Pub. No.: US 2018/0019463 A1
(43) Pub. Date: Jan. 18, 2018

(54) LITHIATED SILICON/CARBON COMPOSITE MATERIALS AND METHOD FOR PRODUCING THE SAME

(71) Applicant: Rockwood Lithium GmbH, Frankfurt am Main (DE)

(72) Inventors: Ulrich Wietelmann, Friedrichsdorf (DE); Ute Emmel, Frankfurt am Main (DE); Gerd Krämer, Bad Vilbel (DE); Christopher Kurth, Rodgau (DE); Stefan Scherer, Griesheim (DE); Thorsten Buhrmester, Darmstadt (DE)

(21) Appl. No.: 15/546,746

(22) PCT Filed: Jan. 27, 2016
(86) PCT No.: PCT/EP2016/051680

§ 371 Date: Jul. 27, 2017

(30) Foreign Application Priority Data
Jan. 28, 2015 (DE) 10 2015 201 461.4

(51) Int. Cl. H01M 4/36; H01M 4/587; H01M 4/38; H01M 10/0525

(52) U.S. Cl. CPC H01M 4/364; H01M 10/0525; H01M 4/587; H01M 4/366; H01M 4/382; H01M 4/386

(57) ABSTRACT

The invention relates to composite materials of general composition SiₓC₁₀₋ₓLi in which x can be any value from 1-9 and z=a(4,4x+1/6(10-x)) and a=any value from 0.1-1, which can be used as highly capacitive anode materials for galvanic cells with non-aqueous electrolytes, and to a method for the production thereof.

The invention relates to lithiated composite materials consisting of the elements Li, Si and C, wherein the electrochemical rest potential of these compounds is below approximately 2 V, preferably below 1 V measured against Li/Li⁺.

Silicon is one of the most-promising anode materials for lithium batteries of the next generation. The semimetal has an extremely high absorbing capacity for lithium via the mechanism of alloy formation: therefore, for example the alloy Li₂₂Si₅ has a maximum theoretical capacity of 4200 Ah/kg; therefore, it is more than ten times higher than the graphites currently built into lithium ion batteries (372 Ah/kg). Unfortunately, the high volume changes (>300%) during charging/discharging result in a pulverizing and a separation of the connection from the current conductor so that a poor reversibility and an extremely rapid capacity drop take place. For graphene a reversible capacity of 740 mAh corresponding to a composition LiC₃ according to the document US 2015/0000118 A 1 is considered to be possible.

The electrochemical properties of silicon can be improved by reducing the particle sizes in the submicron range, by alloy formation with other elements, nanostructuring of electrodes or by admixing components which buffer the volume change (e.g., carbon).

When using silicon as anode material in lithium batteries there is another problem in that very high, irreversible losses are recorded during the first charge/discharge cycle. They can be traced back primarily to the content of foreign elements such as, e.g., oxygen, hydrogen and inorganic carbon (e.g., carbonate). The foreign elements react irreversibly with lithium to electrochemically inactive products such as lithium oxides, lithium carbonate, lithium carbide, lithium hydroxide, etc.

### POSING OF THE PROBLEM

A material mainly based on silicon is sought which when used as anode material in galvanic cells, e.g., lithium batteries, has
1. low, irreversible initial losses,
2. a high-capacity of at least 500, preferably at least 1000 Ah/kg and
3. a sufficient cycle stability.

This material should be able to be produced by a commercially advantageous process.

### SOLUTION OF THE PROBLEM

The problem is solved with a composite material consisting of the tribochemically/thermally produced conversion product of graphitic or graphene-like carbon with elementary silicon and elementary lithium.

In general, the composite materials according to the invention have the following empirical formula:

SiₓC₁₀₋ₓLi_{z}, wherein

x can assume any value from 1 to 9 and z=a(4,4x+1/6(10-x)) with a=any value from 0.1 to 1. The amount of the lithium in the composite material is therefore in the range of 10 to 100 mol % of the stochiometrically maximally possible lithium absorption (LiC₆ and Li₂₂Si₅ are the thermodynamically stable phases which are the richest in lithium at room temperature).

The production of the composite materials of the invention takes place for example via a grinding process which can be optionally combined with a tempering process. To this end the graphitic material (for example graphite powder with grain sizes between 5 and 200 μm) or graphene power with silicon powder (grain size 1 to 100 μm) in a molar ratio of 9:1 to 1:9 and with lithium powder (grain size 5 to 500 μm) is mixed under inert gas conditions (e.g., Ar) and is subsequently compressed or ground. At this time at first Li-graphite intercalates with the composition LiC₀ (o=e.g., 6 or 12) surprisingly form at first whereas no or only an entirely subordinate reaction or alloy formation takes place between silicon and lithium metal.

The mechanically induced conversion takes place in the temperature range between 0 and 120° C., preferably 20 to 100° C. either in vacuum or under an atmosphere whose components do not react or only acceptably slowly react with metallic lithium, silicon and/or lithium graphite intercalation compounds. This is preferably either dry air or a noble gas, especially preferably argon.

The lithium is added in powdery form consisting of particles with an average particle size between about 5 and 500 μm, preferably 10 and 200 μm. Coated powders such as, e.g., a stabilized metallic powder offered by the FMC company (Lectromax powder 100, SLMP) with a lithium content of at least 97% or, for example, a powder coated with alloy-forming elements and with metallic contents of at least 95% (WO2013/104787A1) are used. Non-coated lithium powders with a metallic content of ≧99% are especially preferably used. For a use in the battery area the purity regarding metallic contaminations must be very high. Among other things, the sodium content must not be >200 ppm. The Na content is preferably ≦100 ppm, especially preferably ≦80 ppm.

All powdery graphite qualities, both those from naturally occurring ones (so-called “natural graphite”) as well as synthetically/industrially produced types (“synthetic graphite's”) can be used as graphite. Macrocrystalline flake graphites as well as amorphous or microcrystalline graphites can be used. As regards graphenes, there is basically no limitation. However, the oxygen content should be below 5, preferably 1 wt %. The silicon powder has a content of at least 80, preferably at least 90% Si; it is assumed that the remainder consists substantially of oxygen to 100%.

The conversion (that is the lithiation or partial lithiation) of the graphite or graphene takes place during admixing, compression and/or grinding of the two components lithium powder and graphite—or graphene powder in the presence of the Si powder. The grinding can take place by mortar and pestle on a laboratory scale. However, the conversion preferably takes place in a mechanical mill, for example, a rod mill, oscillating mill or ball mill. The conversion is especially advantageously carried out in a planet ball mill. To this end, e.g., the planet ball mill Pulverisette 7 premium line from the Fritsch company can be used on a laboratory scale. When using planet ball mills very advantageously short reaction times of <10 h, frequently even <1 h can be surprisingly achieved.

The mixture of lithium powder and graphite powder is preferably ground in the dry state. However, a fluid which is inert to both substances can also be added up to a weight ratio of up to 1:1 (sum of Li+C+Si:fluid). The inert fluid is preferably a non-aqueous hydrocarbon solvent, e.g., a liquid alkane or alkane mixture or an aromatic hydrocarbon mixture. The vigorousness of the grinding process is dampened and the graphite particles are ground less strongly by the addition of solvents.

The grinding time is a function of various requirements and process parameters:
weight ratio of grinding balls to product mixture
type of grinding balls (e.g., hardness and density)
intensity of the grinding (frequency of rotation of the grinding plate)
reactivity of the lithium powder (e.g., type of coating)
weight ratio of Li:C
product-specific material properties
desired particle size, etc.

The conditions can be discovered by a person skilled in the art by simple optimizing experiments. In general, the grinding times fluctuate between 5 minutes and 24 hours, preferably between 10 minutes and 10 hours. After the end of the mechanochemical conversion a composite is present consisting of lithiated or partially lithiated graphite/graphene powder, largely unchanged Si-Powder and lithium metallic remainders.

These lithiated or partially lithiated composite powders are “active” to environmental conditions (air and water) and to many functionalized solvents (e.g., NMP) and liquid electrolyte solutions, i.e. they react or decompose upon rather long exposure times. When stored in normal air the contained lithium reacts under the development of hydrogen to thermodynamically stable salts such as lithium hydroxide, lithium oxide and/or lithium carbonate. In order to at least largely avoid this disadvantage, the lithiated or partially lithiated composite powders can be stabilized by a second process step, a coating method. To this end the lithiated or partially lithiated composite powder is passivated with a gaseous or liquid coating agent. The coating agents used contain, compared to metallic lithium and lithium graphite intercalation compounds or lithium graphene intercalation compounds, reactive functional groups or molecular constituents and they therefore react with the lithium available on the surface. The conversion of the lithium-containing surface zone takes place under the formation of lithium salts such as, e.g., lithium carbonate, lithium fluoride, lithium hydroxide, lithium alcoholates, lithium carboxylates, etc.) which are non-reactive or only slightly reactive to air (therefore thermodynamically stable). In this coating procedure the greatest part of the lithium which is not present on the particle surface (e.g. of the intercalated component) remains in active form, i.e., with an electrochemical potential of ≦1 V vs. Li/Li+. Such coating means are known from lithium ion battery technology as in-situ film producers (also designated as a SEI producers) for the negative electrodes and are described, for example, in the following survey article: A. Lex-Balducci, W. Henderson, S. Passerini, Electrolytes for Lithium Ion Batteries, in Lithium-Ion Batteries, Advanced Materials and Technologies, X. Yuan, H. Liu and J. Zhang (Hrsg.), CRC Press Boca Raton, 2012, p. 147-196. Coating agents used are cited by way of example in the following. Suitable gases are N₂, CO₂, CO, O₂, N₂O, NO, NO₂, HF, F₂, PF₃, PF₅, POF₃ and the like. Liquid coating agents used are, for example: carbonic acid esters (e.g., vinylene carbonate (VC), vinyl ethylene carbonate (VEC), ethylene carbonate (EC), propylene carbonate (PC), dimethyl carbonate (DMC), diethyl carbonate (DEC), ethyl methyl carbonate (EMC), fluoroethylene carbonate (FEC)); lithium chelateoborate solutions (e.g., lithium bis(oxalato)borate (LiBOB), lithium bis(salicylato)borate (LiBSB), lithium bis(malonato)borate (LiBMB), lithium difluorooxalatoborate (LiDFOB) as solutions in organic solvents, preferably selected from: oxygen-containing heterocycles such as THF, 2-methyl-THF, dioxolan; carbonic acid esters (carbonates) such as ethylene carbonate, propylene carbonate, dimethyl carbonate, diethyl carbonate and/or ethyl methyl carbonate; nitriles such as acetonitrile, glutarodinitrile; carboxylic acid esters such as ethylacetate, butylformiate and ketones such as acetone, butanone; sulfur-organic compounds (e.g., sulfites, (vinylethylene sulfite, ethylene sulfite); sulfones, sultones and the like); N-containing organic compounds (e.g., pyrrole, pyridine, vinylpyridine, picolines, 1-vinyl-2-pyrrolidinone); phosphoric acid; organic, phosphorus-containing compounds (e.g., vinyl phosphonic acid); fluorine-containing organic and inorganic compounds (e.g., partially fluorinated hydrocarbons, BF₃, LiPF₆, LiBF₄), silicon-containing compounds (e.g., silicon oils, alkyl siloxanes) among others.

When using liquid coating agents the coating process generally takes place under an atmosphere of inert gas (e.g., argon protective atmosphere) at temperatures between 0 and 150° C. In order to increase the contact between the coating agent and the lithiated or partially lithiated composite powder, mixing or agitating conditions are advantageous. The necessary contact time between the coating agent and the lithiated or partially lithiated composite powder is a function of the reactivity of the coating agent, of the prevailing temperature and of other process parameters. In general, times between 1 minute and 24 hours are appropriate.

The coating not only improves the handling properties and the safety in the production of electrodes (generally anodes) but also the properties of use in an electrochemical battery cell. When pre-coated anode materials are used, the in situ formation of an SEI (solid electrolyte interface) is eliminated upon contact of the lithiated or partially lithiated composite anode material with the liquid electrolyte of the battery cell. The anode filming brought about outside of the electrochemical cell by pre-coating corresponds in its properties to a so-called artificial SEI. In the ideal case the otherwise necessary forming process of the electrochemical cell is eliminated or it is at least simplified.

The composite products lithiated or partially lithiated and stabilized according to the above-described method can be used to produce battery electrodes. For this, they are mixed and homogenized under inert or drying room conditions with at least one binder material and optionally with a conductivity-improving additive (e.g., blacks or metallic powder, e.g., Ni powder or Ni foam) and with an organic solvent and this dispersion is applied by a coating method (casting method, spin coating or airbrush method) onto a current conductor and dried.

The stabilized lithiated or partially lithiated composite powders produced according to the method of the invention are surprisingly not very reactive to N-methylpyrrolidone (NMP) and to other functionalized, organic solvents. Therefore, they can be processed with NMP and the binder material polyvinylidene difluoride (PVdF) to a castable or sprayable dispersion. Other examples for suitable binder materials are, among others: carboxymethyl cellulose (CMC), polyisobutylene (e.g., Oppanol of the BASF Company), alginic acid.

In a preferred variant of the method according to the invention the described, non-coated, lithiated or partially lithiated composites are subjected following the mechanochemical conversion to a temperature step at temperatures between 100 and 350° C., preferably between 150 and 250° C. During a tempering time of 5 minutes to 24 h a conversion takes place between the lithiated or partially lithiated graphite-/graphene compounds and optionally any elementary (metallic) lithium still present to alloys of lithium and silicon (lithium silicides, e.g. Li₇Si₃). Upon maintaining sufficient storage times at a certain temperature it is possible to extract all lithium intercalated in the graphite or graphene and to use it for the production of the lithium silicides. In this manner a silicide composite is produced in the extreme case which consists of lithium-free or very lithium-poor graphite/graphene and lithium silicides. The exact composition results from the stoichiometry of the reaction batch.

In a variant of a method the silicide composite materials of the invention with the empirical formula SiₓC₁₀₋ₓLi_{z} can also be produced by mixing separately produced, powdery LiC₀ intercalation compounds (o=30-6) with silicon powder (1-100 μm grain size) in the desired molar ratio and in a subsequent thermolysis phase (130 to 350° C. for 5 min to 24 h, preferably 140-300° C.

It was surprisingly found that the non-coated, lithiated or partially lithiated composites as well as the silicide composites in contact with electrolytic solutions and carbonate solvents are more stable than pure lithium-graphite intercalation compounds. Therefore, it was found that the following beginning of an exothermal decomposition can be observed for composites produced in the molar ratio Si:C:Li=1:2, 7:3, 9 when stored in a mixture of ethylene carbonate/ethyl methyl carbonate (EC/EMC, 1:1 w/w in the DSC experiment) Radex system of the Systag company:
Non-coated lithium graphite intercalation compound LiC₆ (Li content=8.8%) Tₒₙₛₑₜ=130° C.
Non-thermolyzed Li/Si/C—composite with the composition Li_{3,9}SiC_{2,7} (Li content=31%): Tₒₙₛₑₜ=170° C.
At 150° C. 4 hours thermolyzed Li/Si/C—composite with the composition Li_{3,9}SiC_{2,7} (Li content=31%): Tₒₙₛₑₜ=140° C.
At 250° C. 10 hours thermolyzed Li/Si/C—composite with the composition Li_{3,9}SiC_{2,7} (Li content=31%): Tₒₙₛₑₜ=150° C.

In spite of the lithium concentration in the composite materials according to the invention, which is significantly higher in comparison to LiC₆, the materials according to the invention have an improved thermal stability compared to an EC/EMC mixture.

Furthermore, it was surprisingly found that the composite materials are not self-igniting in air as a rule. This is the opposite of the behavior of non-coated LiC₆.

The electrochemical rest potential of the composite material of the invention is below about 2 V, preferably below 1 V measured against Li/Li⁺.

The composite materials according to the invention can be used as high-capacitive anode materials for galvanic cells with non-aqueous electrolytes, for example lithium batteries.

### EXAMPLE 1

A mixture consisting of:
1.80 g Si powder (supplier Wacker, Si content 89.4%, D₅₀=58 μm)
1.16 g Li powder (Rockwood lithium, non-coated, Li content>99%, D₅₀=105 μm)
3.00 g graphite powder (SLP 30 from the Timcal company)
   was ground together with 26 ZrO₂ balls, diameter 3 mm 4 h at 400 rpm in a reversion operation in a planet ball mill Pulverisette P 7 with a zirconium oxide grinding cup from the Fritsch company in a glove box filled with Ar.

5.56 g of a golden-brown powder was obtained. The phases LiC₁₂, LiC₆Si metal and Li metal can be identified in this product by powder x-ray diffractometry. Graphite and Li/Si alloys cannot be identified.

The product surprisingly proved to be non-self-igniting in air. It vigorously reacts with N-methylpyrrolidone after a short time.

### EXAMPLE 2

1.05 g of a mixture produced according to example 1 are thermolyzed in closed steel autoclaves in Ar protective gas for 4 hours at 150° C. Subsequently, the following phases can be identified by XRD: lithium silicides, graphite and Si (reduced intensity). Metallic lithium cannot be identified.

The product is not self-igniting in air. It reacts mildly with NMP at room temperature.

### EXAMPLE 3

1.16 g of a mixture produced according to example 1 are thermolyzed in closed steel autoclaves in Ar protective gas for 10 hours at 250° C. Subsequently, the following phases can be identified by XRD: lithium silicides (elevated intensity), graphite and Si (greatly reduced intensity). Metallic lithium cannot be identified.

The product is not self-igniting in air. It reacts only extremely weakly with NMP at room temperature.

The examples show the production of Li/C/Si composites with a high lithium content and their qualitative composition. A thermal post-treatment improves the stability to reactive solvents shown, for example, on a mixture with N-methyl pyrrolidone.

1. Composite materials with the empirical formula SiₓC₁₀₋ₓLi_{z}, wherein x can assume any value from 1 to 9 and z=a(4,4x+1/6(10-x)) with a=any value from 0.1 to 1, characterized in that they consist of an intimate mixture consisting of lithiated or partially lithiated graphite or graphene, powdery silicon with particle sizes between 1 and 100 μm and optionally of metallic lithium.

2. Composite materials with the empirical formula SiₓC₁₀₋ₓLi_{z}, wherein x can assume any value from 1 to 9 and z=a(4,4x+1/6(10-x)) with a=any value from 0.1 to 1, characterized in that they consist of an intimate mixture consisting of powdery lithium silicides and (partial)- or non-lithiated graphite or graphene.

3. Stabilized composite materials with the empirical formula SiₓC₁₀₋ₓLi_{z}, characterized in that the composite materials according to claim 1 or 2 comprise a stabilizing coating layer which is applied by a post-treatment with one or more gaseous or liquid coating means.

4. A method for producing composite materials with the empirical formula SiₓC₁₀₋ₓLi_{z}, wherein x can assume any value from 1 to 9 and z=a(4,4x+1/6(10-x)) with a=any value from 0.1 to 1, characterized in that a mixture of silicon powder with a grain size of 1 to 100 μm with lithium powder with a grain size of 5 to 500 μm and graphite- and/or graphene powder in a molar ratio of Si/C/Li x/10-x/z is mechanochemically converted in a temperature range of 0 to 120° C., preferably 20 to 100° C. under inert gas or in a vacuum.

5. A method for the production of silicide composite materials with the empirical formula SiₓC₁₀₋ₓLi_{z}, wherein x can assume any value from 1 to 9 and z=a(4,4x+1/6(10-x)) with a=any value from 0.1 to 1, characterized in that a mixture of silicon powder with a grain size of 1 to 100 μm with lithium powder with a grain size of 5 to 500 μm and graphite- and/or graphene powder are at first converted in the indicated molar ratio of Si/C/Li x/10-x/z mechanochemically in a temperature range of 0 to 120° C., preferably 20 to 100° C. under inert gas or in a vacuum and the mixture obtained is subsequently subjected to a thermolysis phase in a temperature range of 150 to 350° C. for 5 minutes to 24 h.

6. A method for the production of silicide composite materials with the empirical formula SiₓC₁₀₋ₓLi_{z}, wherein x can assume any value from 1 to 9 and z=a(4,4x+1/6(10-x)) with a=any value from 0.1 to 1, characterized in that a mixture of powdery, non-coated LiC₀-intercalation compounds with o=30-6 with silicon powder with a grain size of 1 to 100 μm is mixed in the indicated molar ratio of Si/C/Li x/10-x/z and is subsequently subjected to a thermolysis phase in a temperature range of 130 to 350° C. for 5 minutes to 24 h, preferably 140-300° C.

7. A method for the production of stabilized silicide composite materials with the empirical formula SiₓC₁₀₋ₓLi_{z}, wherein x can assume any value from 1 to 9 and z=a(4,4x+1/6(10-x)) with a=any value from 0.1 to 1, characterized in that the composite materials produced according to one or more of claims 4 to 6 are subsequently treated with a gaseous or liquid coating agent.

8. The method according to example 7, characterized in that the gaseous coating agents are selected from the group N₂, CO₂, CO, O₂, N₂O, NO, NO₂, HF, F₂, PF₃, PF₅, POF₃ and the liquid coating agents are selected from the group of carbonic acid esters; the lithium chelatoborate solutions as solutions in organic solvents, preferably selected from: oxygen-containing heterocycles, the carbonic acid esters, nitriles, carboxylic acid esters and ketones, sulfur-organic compounds: sulfites, sulfones, sultones; N-containing organic compounds, phosphoric acid, organic, phosphorus-containing compounds, fluorine-containing organic and inorganic compounds, partially fluorinated hydrocarbons, BF₃, LiPF₆, LiBF₄, silicon-containing compounds.

9. The use of the composite materials with the empirical formula SiₓC₁₀₋ₓLi_{z} as anode material in galvanic cells with non-aqueous electrolytes, for example, lithium batteries.
